(19) United States
(12) Patent Application Publication
(10) Pub. No.: US 2005/0226990 A1
(43) Pub. Date: Oct. 13, 2005

(54) Fortified confectionery products

(76) Inventors: Juan Jose Pellecer, Ithaca, NY (US); Lisa Pitka, Santa Clara, CA (US); Kenneth F. Rowe, Princeton, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/092,235

(22) Filed: Mar. 29, 2005

Related U.S. Application Data
(60) Provisional application No. 60/558,465, filed on Apr. 1, 2004.

(51) Int. Cl. A23G 3/00

(52) U.S. Cl. 426/660

(57) ABSTRACT

A confectionery chew for lowering serum cholesterol in an animal in need thereof including a carbohydrate, a seeding agent, which can be a fondant, a structuring agent, which can be a protein, a starch, a hydrocolloid, and mixtures thereof, and cholesterol lowering agent selected from a sterol, a sterol ester, a stanol, a stanol ester, and mixtures thereof.

This application claims the benefit of U.S. Provisional Application No. 60/558,465, filed Apr. 1, 2004, which is incorporated herein by reference in its entirety.

### FIELD OF THE INVENTION

The present invention relates to fortified confectionery products that are useful for lowering serum cholesterol levels in an animal in need thereof. In particular, the present invention relates to confectionery delivery systems, such as chews, that have been fortified with a phytosterol, phytosterol esters, and other waxy substances that are useful in lowering serum cholesterol in an animal in need thereof.

### BACKGROUND OF THE INVENTION

It has been shown that the addition of plant sterols (phytosterols), such as, β-sitosterol, campesterol and stigmasterol, to diets will reduce serum cholesterol levels. Such sterols reduce serum cholesterol through the disruption of intestinal absorption of dietary cholesterol by displacing it from bile acid micelli. More recently, β-sitosterol's saturated derivative, β-sitostanol, has been shown to be more effective in the reduction of intestinal cholesterol absorption. The sitostanol itself is virtually unabsorbed, so it does not contribute at all to in vivo serum sterol concentration upon consumption. Unfortunately, typical sterols and stanols are insoluble in the micelli phase of the alimentary canal and have only limited solubility in oils and/or fats or water. Hence, free sterols or stanols themselves are not optimum candidates for use in typical pharmaceutical or dietary dosage forms as cholesterol reducing agents.

There have been reports that describe how the esterification of sterols (in this specification the term sterol will be used to refer to either sterols or stanols) with a fatty acid or an edible oil produces a sterol ester with improved solubility characteristics. It has also been suggested that these low melting lipophilic esters are more soluble in the micelle phase during the digestive process. These esters have been incorporated effectively into, for example, margarine, for use as a palatable dietary supplement.

Chews, such as, the well-known fudges, caramels, toffees, grained caramels, and fruit chews, are confectionery products on the basis of fat, sugar, water and flavoring. Chews are used both as such and as fillings of (e.g., chocolate) coated products. They are characterized by a relatively firm rheology at room temperature, but a quick-melting behavior, easy chewability and workability at higher temperatures, in particular at mouth temperature.

U.S. Pat. No. 6,673,380, the entire content of which is incorporated herein by reference, discloses chewy confectionery products, and processes for producing said products, are provided as delivery systems for minerals, such as, calcium. The carbohydrates of the fortified confectionery products include at least one reducing sugar and one non-reducing sugar in a weight ratio of about 1:0.2 to about 1:1 reducing sugar:non-reducing sugar. The chewy confectionery products offer a matrix for about 0.2 wt. % to 45 wt. % of a fortifying component while maintaining a smooth and soft texture. Phytosterols were disclosed as being able to be used in the disclosed confectionery delivery systems. However, the invention described therein required a fortification component in addition to the phytosterol. What is needed is a confectionery product that requires a sterol, sterol ester, and combinations thereof, with other optional fortifying components, where the confectionery product is a chews, such as, the well-known fudges, caramels, toffees, grained caramels, and fruit chews that is stable and has good mouthfeel to the user.

The present invention solves those and other needs. In particular, the present invention relates to the use of sterol, sterol ester, and mixtures thereof in combination with seeding agents (such as, fondant or confectioner's sugar) and a range of sugar ratios (reducing to non-reducing) that are designed to deliver a confectionery product with an improved eating quality. This invention is directed to confectionery products like grained caramels, fudges, and fruit chews that can be modified to improve their eating qualities from a long, chewy texture to a short fudgy texture with a fine crystal structure and good stability.

### SUMMARY OF THE INVENTION

One embodiment of the present invention is an individual confectionery chew comprising, consisting essentially of and/or consisting of an effective amount of a carbohydrate, an effective amount of a seeding agent, an effective amount of a structuring agent selected from a protein, a starch, a hydrocolloid, and mixtures thereof, a serum cholesterol-lowering amount of a cholesterol lowering agent selected from the group consisting of sterol, sterol ester, stanol, stanol ester, and mixtures thereof. Another embodiment of the present invention includes an individual confectionery chew for lowering serum cholesterol in an animal in need thereof comprising, consisting essentially of and/or consisting of from about 40 wt. % to about 70 wt. % of a carbohydrate, from about 2 wt. % to about 8 wt. % of a fondant; from about 0.01 wt. % to about 20 wt % or of a protein, a serum cholesterol-lowering amount of a sterol, sterol ester, and mixtures thereof.

### DETAILED DESCRIPTION OF THE INVENTION

As used herein, dextrose equivalent (DE) is defined as the percent of reducing sugars on a dry basis calculated as dextrose. As familiar to one skilled in the art, glucose (or corn) syrups are formed by reacting a starch with an acid and/or enzyme. The DE is a measurement of the degree of hydrolysis that starches undergo to yield different DE syrups. As used herein, glucose and dextrose are used interchangeably. Standard corn syrups are defined as having about a DE value of approximately 42. Syrup processed to have a “high” DE have a value of approximately 65 DE. The higher the level of DE in a carbohydrate component, the sweeter the ingredient. With the sweetness factor, the high DE carbohydrates may also contribute to negative product characteristics, such as, greater tendency to crystallize (could lead to a product defect if there's too much or too big of a crystal formulation); less viscosity (could lead to a product that is too sticky, inability to hold form); tendency to brown (could lead to flavor problems and coloration problems); tendency to be more hygroscopic (could lead to product that has too much crystallization); and so on. A “reducing sugar” is defined as a sugar which can chemically react with a special copper reagent known as Fehlings solution (alkaline solution), whereby the “reducing” sugar will reduce this copper solution to copper oxide (cuprous oxide). Corn syrups, fructose and milk sugars are examples of reducing sugars. A “non reducing sugar” is defined as a sugar that will not react with the special copper reagent. Sucrose is an example of a common non-reducing sugar. As used herein, all numerical ranges provided are intended to expressly include at least all numbers that fall between the endpoints of ranges.

The carbohydrates used in the invention may be selected from any source commonly used in the art of preparing confectionery products (see, e.g. Food Technology, March, 1991, pp. 148-149, hereby incorporated by reference). More particularly, the carbohydrate preferably has at least one reducing sugar and at least one non-reducing sugar. The carbohydrate preferred may also be defined as comprising an effective amount, including from about 10 to about 50 wt. % of an oligosaccharide, a polysaccharide or a mixture thereof and from about 50 to about 90% of a monosaccharide, a disaccharide, or a combination thereof. Sugars falling into the category of monosaccharide, disaccharide, polysaccharides, etc. are readily ascertainable by one skilled in the art (see, e.g. Food Technology article cited herein). More preferably from about 20 to about 50 wt. %, most preferably from about 22 to about 36 wt. % of the carbohydrate is selected from oligosaccharides, polysaccharides and mixtures thereof.

The ratio of the reducing sugar:non-reducing sugar is from about 1:0.2 to about 1:1, from about 1:0.3 to about 1:0.8, from about 1:0.3 to about 1:0.4 or from about 1:0.5 to about 1:2.5, about 1:0.7 to about 1:1.5, or about 1:0.9 to about 1:1.5. In addition to the reducing and non-reducing sugars, the carbohydrate fraction of the confectionery may include other carbohydrate components, such as, lactose, maltodextrin and the like (which will permit formulations having fewer calories). More particularly, various corn syrups (starch hydrolysates), polydextrose (polymer of dextrose with sorbitol and an acid), sucrose, dextrose, fructose, lactose, maltose, brown sugar, cane sugar, and beet sugar; invert sugar; sugar alcohols (sorbitol, maltitol, mannitol, xylitol), honey; lycasin and mixtures thereof may be selected as the carbohydrate component. More preferably employed is at least one reducing sugar selected from corn syrup (about 24 DE to about 65 DE), high fructose corn syrup, corn syrup solid, high maltose corn syrup, fructose, invert sugar, and mixtures thereof is employed with at least one non-reducing sugar (such as sucrose and the like) is used. In addition to the non-reducing and reducing sugars, artificial sweeteners may also be used as sweetening agents, such as aspartame, saccharin, lactitol, sucralose, acesulfame-K, stevia; Neohesperidine DC, cyclamates and the like. Particularly preferred carbohydrates are sucrose (the non-reduced sugar) combined with reducing sugars described in Table 1 below.

TABLE 1
Sources of Reducing Sugars

| | | High Maltose | High | |
|---|---|---|---|---|
| Corn Syrup - | Corn Syrup - | Corn Syrup - | Fructose | |
| 42DE | 62/63 DE | 42 DE | Corn Syrup | Fructose |
| | X | X | | |
| X | | | | X |
| | | X | X | |
| X | | | X | |
| | X | X | X | |
| X | X | | X | |
| | X | X | X | |
| X | X | | | |

As described in the Table 1, the non-reducing sugar, preferably sucrose, may be combined with various combinations of reducing sugars selected from the following combinations: (1) a corn syrup having a DE of 62/63 with a high maltose corn syrup having a 42 DE, (enzymatically treated corn syrup resulting in the production of a maltose); (2) a corn syrup (42 DE) and fructose; (3) a high maltose corn syrup (42 DE) with a high fructose corn syrup; (4) a corn syrup (42 DE) and a high fructose corn syrup; (5) a corn syrup (62/63 DE), high maltose corn syrup, and a high fructose corn syrup;(6) a corn syrup (42 DE) and a corn syrup (62/63 DE), and a high fructose corn syrup; (7) a corn syrup (42 DE) and a corn syrup (62-63 DE).

The confectionery is defined as having an effective amount, including at least about 40 wt. % carbohydrate. Preferably from about 40 wt. % to 70 wt. %, more preferably, from 50 to 60 wt. % of the carbohydrate is employed in the confectionery.

The present invention also requires an effective amount of a structuring agent to provide structure. The structuring agent selected from a protein, a starch, a hydrocolloid, and mixtures thereof, Examples of protein sources include milk solids, sweetened condensed skim milk, and soy. Starch sources include corn, tapioca, rise, wheat and potato Hydrocolloids sources include agar, xanthan gum, gellan gum, gelatin, gum Arabic, pectin, and alginate. The structuring agent can be any effective amount, including from about 0.01 to about 20 wt % or from about 0.1 to about 5 wt % of the final product.

The composition may be processed in any standard candy making machinery, either in a batch process using open pan cooking or in a continuous system. In a continuous system, the basic mix may be caramelized and other ingredients added thereafter. The cooked mass may then be poured onto a cooling table, cut and further processed on a standard caramel wrapping machine. The confectionery product may be further processed in any acceptable commercial form including bars, rolls, individually wrapped pieces and so on. The physical characteristics of softness preferably do not interfere with individually wrapping the confectionery products. Wrapping materials may be selected from any known, non-reactive material used in the food industry. The composition may be formulated using any flavor technology (natural, artificial, nature identical), including, but not limited to. preparations as a caramel, chocolate, fruit, e.g., strawberry, raspberry, blueberry, and the like, or mint, e.g., spearmint, peppermint and the like, and mixtures thereof, or other flavored confectionery chew product.

The caramel flavor may be contributed to the confectionery naturally during a cooking process or commercially by adding caramel powders, dairy products (e.g., milk crumb) and/or other flavoring ingredients. Cocoa butter, cocoa, cocoa liquor, chocolate flavor, and mixtures thereof are particularly useful in providing an acceptable tasting chocolate confectionery. For fruit flavored confectionery products, flavor may be provided by citric acid, malic acid, and optionally additional fruit juices and/or fruit flavoring commonly used in food technologies.

Advantages presented with the inventive confectionery are that the confectionery products are highly stable as well as good tasting.

The use of fondant and/or confectionery sugar as well as changing the sugar ratio is referenced in the confectionary literature as being used in the production of grained caramels and fudges. These are traditionally made with butter and/or shortening and in some cases the crystallization process is accelerated by shear agitation while cooling.

The products of the present invention can be made by methods known to those of skill in the art. The following documents are incorporated herein by reference.

De Reock, F. R. 1961. Candy Clinic- Fudge. Proceedings of the Fifteenth Annual Production Conference of the Pennsylvania Manufacturing Confectioner's Association.

Groves, R. 1983. Chewy Candies: Production and Problem Solving. (from disk).

Gingrich, B. L. and P. S. Dimick. 1976. Subjective and Objective Evaluation of Milk Caramel. Proceedings of the Thirtieth Annual Production Conference of the Pennsylvania Manufacturing Confectioner's Association.

Jackson, B. 2000. Fundamentals of Sugar Confectionery. The Manufacturing Confectioner. (August 2000- pg 35-41).

Sherman, M. B. 1961. Candy Clinic- Chewy Candies. Proceedings of the Fifteenth Annual Production Conference of the Pennsylvania Manufacturing Confectioner's Association.

Warnecke, M. 1996. Caramel: The Essential Elements. The Manufacturing Confectioner. (June 1996- pg 87-92).

Samples have been prepared on different scales including bench top, pilot plant, and plant scale samples. Samples have further been tested in a consumer acceptance tests and their stability assessed in accelerated stability studies. Results of the consumer acceptance tests will be forthcoming.

The key problem was to develop a stable confectionery product with sterol esters (including stanol esters) that possesses caramel and fudge-like attributes; that is, the product had a fudgy/short texture (vs. a chewy/sticky texture) to address the targeted market preferences. Initially, product with intermediate sugar ratio showed uncontrolled graining resulting in larger sugar crystals and poor eating qualities. The product needed to be modified to achieve a partially fudged product (grained caramel) without compromising product shelf-life. Increasing the sugar ratio and the addition of fondant in combination with the targeted level of stanol ester resulted in a stable, smooth product with the desired eating qualities (e.g., fudgy texture).

The sugar ratio and fondant level combination was further adjusted to deliver a product with not only the desired eating qualities, but also with right texture characteristics needed to be manufactured at the confectionary plant (e.g. packaging window).

Various levels of stanol ester have been tested ranging from about 0.5 to about 1.0 grams of stanols delivered per serving. At the same time, the serving sizes evaluated in combination with the previous stanol levels include about 5.3 to about 10 grams. Scientific studies show that 1.3 grams per day of plant sterol esters or 3.4 grams per day of plant stanol esters in the diet are needed to show a significant cholesterol-lowering effect. About 0.65 grams of plant sterol esters per serving (or about 0.4 g of free phytosterols per serving) or at least 1.7. grams of plant stanol esters per serving is a serum cholesterol-lowering amount of a cholesterol lowering agent.

Under the current Food and Drug Administration guidelines, the label must specify that the daily dietary intake of plant sterol esters or plant stanol esters should be consumed in two servings eaten at different times of the day with other foods.

The sugar ratios tested vary from about 1:0.5 to about 1:2.5 (reducing to non-reducing); the preferred ranges are about 1:0.7 to about 1:1.5, and the most preferred ranges are about 1:0.9 to about 1:1.5.

### EXAMPLE 1A

### Fondant Preparation

A fondant is prepared using 80 g of fondant sugar (Amerfond, Domino), 12 g of corn syrup (Cargill) and 8 g of water (tap water). The corn syrup and water are added to a mixing bowl (Kitchen Aid, Model KSM 90) and mixed with wire-whisk 15-30 seconds on setting #1 or until homogenous. One-third of the fondant sugar is added and the mixture is mixed further for an additional 90 seconds. The bowl is scraped down prior to adding another third of the fondant sugar, and then the product is mixed for 90 seconds. The process is repeated for the remaining fondant sugar. The fondant is blended for an additional 3 minutes and then transferred to a sealed container.

### EXAMPLE 1B

Fondant is prepared using 40 kg of fondant sugar, 6 kg of corn syrup and 4 kg of water. The ingredients are gradually added into a large Hobart mixer and mixed for 5 minutes. The finished fondant is held in plastic-covered Hobart bowls until weighed for production.

### EXAMPLE 2

### Caramel-flavored Stanol Ester Confectionary

186 g stanol ester (Raisio US) is melted to 150° F. in a kettle with temperature control devices (Presto, 6 qt. multi-cooker). 7 g of lecithin (Archer Daniels Midland) is added to the melted stanol ester and blended until homogenous. Then, 478 g of corn syrup (Cargill), pre-warmed in a microwave oven (household type, 1100 Watts, 100% power) for 20 seconds, and 238 g of sweetened condensed skim milk (Borden Eagle Brand) pre-warmed in a microwave oven (household type, 1100 Watts, 100% power) for 30 seconds are added. The mixture is stirred continuously as ingredients were added to the kettle and slowly heated on setting warm. 7 g of salt (Cargill, Top Flo) is dissolved in 78 g of water (tap water), and then added to the mixture. While continuing to agitate the mixture, 367 g of sucrose (Domino) is added. A Braun mixer (type 4185, 200 Watts) is used to blend the ingredients for 2 minutes on setting high. The temperature after blending is approximately 140-145° F. The mixture was continuously agitated and heated until the temperature reached 243° F. to produce a caramel base. After the cooking was completed, 1 kg of the cooked base was weighed out, poured into a mixing bowl (Kitchen Aid, Model KSM 90) and mixed for 2 minutes on setting #1 with flat-type beater. 65 g of the prepared fondant from Example 1, 1.6 g of caramel flavor (Givaudan flavors) and 0.3 g of vanillin (Rhodia) are added and mixed in for 2 minutes on setting #2. The resulting confectionery is poured into vegetable oil-sprayed aluminum pans and allowed to cool to room temperature.

### EXAMPLE 3

### Chocolate-flavored Sterol Ester Confectionary

115 g of sterol ester (Cargill) is melted to 150° F. in a kettle with temperature control devices (Presto, 6 qt. multi-cooker) and then 5 g of lecithin (Archer Daniels Midland) is added and blended until homogenous. Next, 288 g of corn syrup (Cargill) pre-warmed in a microwave oven (household type, 1100 Watts, 100% power) for 20 seconds and 152 g of sweetened condensed skim milk (Borden Eagle Brand) pre-warmed in a microwave oven (household type, 1100 Watts, 100% power) for 30 seconds are added. The mixture is stirred continuously and heated slowly on setting warm as ingredients are added to the kettle. 5 g of salt (Cargill, Top Flo) was dissolved in 60 g of water (tap water), and then added to the mixture. While continuing to agitate the mixture, 256 g of sucrose (Domino) is added. A Braun mixer (type 4185, 200 Watts) is used to blend the ingredients for 2 minutes on setting high. The temperature after blending is approximately 140° F.-145° F. The mixture is continuously agitated and heated until the temperature reached 243° F. to produce a chocolate base. After the cooking is completed, the cooked base and 25 g of cocoa powder are transferred to a mixer (Kitchen Aid, Model KSM 90) and mixed for 2 minutes on setting #1, scraping down the bowl between minutes. The chocolate flavored confectionary is poured into vegetable oil-sprayed aluminum pans and allowed to cool to room temperature.

### EXAMPLE 4

### Chocolate-flavored Sterol Confectionary

41 g of a soft shortening (ACH Humko) is melted to 150° F. in a kettle with temperature control devices (Presto, 6 qt multi-cooker). 74 g of free sterols (Cargill) are added to the fat and melted to 265° F. in a kettle. Then, the blend is cooled to 225° F. and 5 g of lecithin (ADM) is added and blended until homogenous. Next, 288 g of corn syrup (Cargill) pre-warmed in a microwave oven (household type, 1100 Watts, 100% power) for 20 seconds and 152 g of sweetened condensed skim milk (Borden Eagle Brand) pre-warmed in a microwave oven (household type, 1100 Watts, 100% power) for 30 seconds are added. The mixture is stirred continuously and heated slowly on setting warm as ingredients were added to the kettle. 5 g of salt (Cargill, Top Flo) was dissolved in 60 g of water (tap water), and then added to the mixture. While continuing to agitate the mixture, 256 g of sucrose (Domino) is added. A Braun mixer (type 4185, 200 Watts) is used to blend the ingredients for 2 minutes on setting high. The temperature after blending is approximately 140° F.-145° F. The mixture is continuously agitated and heated until the temperature reaches 243° F. to produce a cooked base. After the cooking is completed, the cooked base and 25 g of cocoa powder are transferred to a mixer (Kitchen Aid, Model KSM 90) and mixed for 2 minutes on setting #1, scraping down the bowl between minutes. The chocolate confectionary is poured into vegetable oil-sprayed aluminum pans and allowed to cool to room temperature.

### EXAMPLE 5

Chocolate-flavored Sterol Ester Confectionary

92 g of sterol ester (Cargill) was melted to 150° F. in a kettle with temperature control devices (Presto, 6 qt. multi-cooker) together with 8 g of a soft shortening (ACH Humko) and 15 g of free sterols (Cargill). Then, the blend is heated to 250° F. until all fats are completely melted. Then, 5 g of lecithin (ADM) is added and blended until homogenous. Next, 288 g of corn syrup (Cargill) pre-warmed in a microwave oven (household type, 1100 Watts, 100% power) for 20 seconds and 152 g of sweetened condensed skim milk (Borden Eagle Brand) pre-warmed in a microwave oven (household type, 1100 Watts, 100% power) for 30 seconds are added. The mixture is stirred continuously and heated slowly on setting warm as ingredients are added to the kettle. 5 g of salt (Cargill, Top Flo) is dissolved in 60 g of water (tap water), and then added to the mixture. While continuing to agitate the mixture, 256 g of sucrose (Domino) is added. A Braun mixer (type 4185, 200 Watts) was used to blend the ingredients for 2 minutes on setting high. The temperature after blending is approximately 140° F.-145° F. The mixture is continuously agitated and heated until the temperature reached 243° F. to produce a cooked base. After the cooking was completed, the cooked base and 25 g of cocoa powder are transferred to a mixer (Kitchen Aid, Model KSM 90) and mixed for 2 minutes on setting #1, scraping down the bowl between minutes. The chocolate confectionary is poured into vegetable oil-sprayed aluminum pans and allowed to cool to room temperature.

### EXAMPLE 6

### Chocolate-flavored Stanol Ester Confectionary

A fondant is prepared as described in Example 1. 30 g of Stanol ester (Raisio US) is melted to 150° F. in a kettle with temperature control devices (Presto, 6 qt. multi-cooker). Then, 30 g of cocoa powder (Gerkens) is blended in until no lumps were visible. The prepared Stanol ester/cocoa powder blend is held in the kettle at 120° F.-140° F. until use. 158 g of stanol ester is melted to 150° F. in a separate kettle (Presto, 6 qt. multi-cooker) and then 7 g of lecithin (ADM) is added and blended until homogenous. Next, 514 g of corn syrup (Cargill) pre-warmed in a microwave oven (household type, 1100 Watts, 100% power) for 20 seconds and 242 g of sweetened condensed skim milk (Borden Eagle Brand) pre-warmed in a microwave oven (household type, 1100 Watts, 100% power) for 30 seconds are added. The mixture is stirred continuously and heated slowly on setting warm as ingredients are added to the kettle. 7 g of salt (Cargill, Top Flo) is dissolved in 88 g of water (tap water), and then added to the mixture. While continuing to agitate the mixture, 345 g of sucrose (Domino) is added. A Braun mixer (type 4185, 200 Watts) is used to blend the ingredients for 2 minutes on setting high. The temperature after blending is approximately 140° F.-145° F. The mixture is continuously agitated and heated until the temperature reached 243° F. to produce a cooked base. After the cooking was completed, 1 kg of the cooked base and 60 g of the stanol ester/cocoa blend are transferred to a mixer (Kitchen Aid, Model KSM 90) and mixed for 2 minutes on setting #1, scraping down the bowl between minutes. 65 g of the prepared fondant and 3 g of chocolate flavor (Givaudan) are added and mixed in for an additional 2 minutes on setting #2. The chocolate confectionary is poured into vegetable oil-sprayed aluminum pans and allowed to cool to room temperature.

### EXAMPLE 7

### Caramel-flavored Stanol Ester Confectionary

A fondant is prepared as described in Example 1. A liquid sucrose (Domino) and non-fat dry milk (Main Street Ingredients) blend is prepared by adding 69 g of non-fat dry milk to 652 g of liquid sucrose and blending with a Braun mixer (type 4185, 200 Watts) for 3 minutes on setting high. Stanol ester (Raisio US) in the amount of 186 g is melted to 150° F. in a kettle with temperature control devices (Presto, 6 qt. multi-cooker). 7 g of lecithin (Archer Daniels Midland) is added to the melted stanol ester while stirring until completely homogeneous. Then, 513 g of corn syrup (Cargill) pre-warmed in a microwave oven (household type, 1100 Watts, 100% power) for 20 seconds and 720 g of the liquid sucrose/non-fat dry milk blend were added. The mixture is continuously stirred as ingredients are added to the kettle. 7 g of salt is added. A Braun mixer (type 4185, 200 Watts) is used to blend the ingredients for 2 minutes on setting high. The temperature after blending is approximately 140-145° F. The mixture is continuously agitated and heated until the temperature reaches 243° F. to produce a cooked base. After the cooking was completed, 1 kg of the cooked base is weighed out, transferred to a mixer (Kitchen Aid, Model KSM 90) and mixed for 2 minutes on setting #1. 65 g of the prepared fondant from Example 1 and 2 g of caramel flavor (Givaudan) are added and mixed in for an additional 2 minutes on setting #2. The caramel is poured into vegetable oil-sprayed aluminum pans and allowed to cool to room temperature.

### EXAMPLE 8

### Caramel-flavored Stanol Ester Confectionary

A fondant is prepared as described in Example 1. A Groen kettle (TDB 7-20) was pre-heated with hot water and 1.1 kg of stanol ester (Raisio US) is added and melted to 140° F. 42 g of lecithin (ADM) is blended in. When the stanol ester and lecithin blend are warmed to 150° F., 2.9 kg of corn syrup (Cargill) is added. Next, 1.4 kg of sweetened condensed skim milk (Borden) is added. The temperature is kept below 150° F. While agitating the mixture, 466 g of tap water, 42 g of salt (Cargill) and 2.2 kg of sucrose (Domino) are blended in. After cooking to 242° F., 7 kg of the base is transferred to a Hobart mixer and mixed at setting #1 until the temperature reaches 180° F. When the base cools to 180° F., 457 g of fondant as prepared in EXAMPLE 1, 11 g of caramel flavor (Givaudan) and 2 g of vanillin (Rhodia) are added. The product is mixed at a high setting for 4 minutes, poured into vegetable oil-sprayed aluminum pans and cooled to room temperature.

### EXAMPLE 9

### Caramel-flavored Stanol Ester Confectionary

A fondant was prepared as described in Example 1. 69 kg of stanol ester (Raisio US) is transferred to a melting tank and heated to 160° F.; then, 2.8 kg of lecithin (ADM) is added and the temperature is held at 150° F. In the premix kettle, 148 kg of sucrose (Domino), 194 kg of corn syrup (Cargill), 95 kg of sweetened condensed skim milk (Dietrich) and 2.8 kg of salt (Cargill) are mixed and heated to approximately 150° F. The stanol ester and lecithin blend is then transferred to the premix kettle and blended with the other ingredients until homogeneous. The ingredient pre-mix is pumped through a continuous vacuum cooker and heated to approximately 236-238 ° F. Next, 159 kg of the product is pumped from the cooker into each of two pre-heated caramelization kettles. 10 kg of the fondant is blended into each of the bases in the caramelization kettles. The finished product is cooled to approximately 95-110° F. in a cooling wheel prior to being transferred to curing pans. The curing pans with the product are held at ambient temperature for 24 hours. After the 24-hour hold, the product is tempered to 95° F. in a hot room for 1-2 hours and then packaged using a fold-and-wrap unit.

The scope of the present invention is not limited by the description, examples and suggested uses herein and modifications can be made without departing from the spirit of the invention. Thus it is intended that the present invention cover the modifications and variations of this invention provided that they come within the scope of the appended claims and their equivalents.

1. An individual confectionery chew comprising:
an effective amount of a carbohydrate,
an effective amount of a seeding agent,
an effective amount of a structuring agent selected from a protein, a starch, a hydrocolloid, and mixtures thereof,
a serum cholesterol-lowering amount of a cholesterol lowering agent selected from the group consisting of a sterol, a sterol ester, a stanol, a stanol ester, and mixtures thereof.

2. An individual confectionery chew of claim 1, wherein the seeding component comprises from about 2 wt % to about 8 wt % of a fondant.

3. An individual confectionery chew of claim 1, wherein the fat is present in an amount of from about 3 to about 18 wt. %.

4. An individual confectionery chew of claim 1, wherein the carbohydrate is present in an amount of from 40 wt. % to about 70 wt %.

5. An individual confectionery chew of claim 4, wherein the carbohydrate comprises a reducing sugar to non-reducing sugar.

6. An individual confectionery chew of claim 5, wherein the reducing sugar to non-reducing sugar ratio is from about 1:0.5 to about 1:2.5.

7. An individual confectionery chew of claim 1, wherein the cholesterol lowering agent is present in an amount to provide at least 0.4 g phytosterol per serving.

8. An individual confectionery chew of claim 1, wherein the cholesterol lowering agent is present in an amount to provide at least 0.65 g stanol ester per serving.

9. An individual confectionery chew of claim 1 wherein the structuring agent is present in an amount of from about 0.01 to about 20 wt %.

10. An individual confectionery chew of claim 9 wherein the structuring agent is present in an amount of from about 0.1 to about 5 wt %.

11. An individual confectionery chew of claim 1 further comprising an effective amount of a fat.

12. An individual confectionery chew for lowering serum cholesterol in an animal in need thereof comprising:
from about 40 wt. % to about 70 wt. % of a carbohydrate,
from about 2 wt. % to about 8 wt. % of a fondant;
from about 0.01 wt. % to about 20 wt % or of a protein,
a serum cholesterol-lowering amount of a stanol, a stanol ester, and mixtures thereof.

13. An individual confectionery chew of claim 12, wherein the carbohydrate comprises a reducing sugar to non-reducing sugar.

14. An individual confectionery chew of claim 13, wherein the reducing sugar to non-reducing sugar ratio is from about 1:0.5 to about 1:2.5.

15. An individual confectionery chew of claim 12, wherein the cholesterol lowering agent is present in an amount to provide at least 0.4 g phytosterol per serving.

16. An individual confectionery chew of claim 12, wherein the cholesterol lowering agent is present in an amount to provide at least 0.65 g stanol ester per serving.

17. An individual confectionery chew of claim 12, wherein the protein is present in an amount of from about 0.1 wt. % to about 5 wt %

18. An individual confectionery chew of claim 12, further comprising from about 3 to about 18 wt. % of a fat.
